(19) United States
(12) Patent Application Publication
(10) Pub. No.: US 2009/0236293 A1
(43) Pub. Date: Sep. 24, 2009

(54) DRAIN GRATE SYSTEM AND METHODS

(76) Inventor: John Alvarado, Santa Ana, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/406,871

(22) Filed: Mar. 18, 2009

Related U.S. Application Data
(60) Provisional application No. 61/037,673, filed on Mar. 18, 2008.

(51) Int. Cl. E03F 5/14; B01D 21/34

(52) U.S. Cl. 210/747; 210/131; 210/163; 404/4

(57) ABSTRACT

A drain grate system can be installed in a curbside or storm drain to block the passage of debris while allowing liquid to flow into the drain. The drain grate system can open in response to a high flow rate to allow liquid and debris to flow into the drain. A locking mechanism can maintain the drain grate system in a closed and locked position and can unlock in response to a predetermined amount of force of a fluid flow.

### CROSS-REFERENCE TO RELATED APPLICATIONS

This application claims the benefit of U.S. Provisional Application No. 61/037,673 filed Mar. 18, 2008, the entirety of which is incorporated herein by reference.

### BACKGROUND OF THE INVENTION

1. Field of the Invention

The application relates generally to the field of street drainage, more specifically to drain grates that are movable in response to water flow therethrough.

2. Description of the Related Art

Road drainage systems such as curb-integrated storm drains are common throughout urban and suburban areas. In these areas, litter, trash, and other debris such as plant trimmings, leaves, and bark may accumulate on the roadway and be blown or washed towards the drains. In dry seasons, when the precipitation is not sufficient to flush the drain systems regularly, the debris may accumulate in the drains.

In a subsequent rainy season, the accumulated debris may clog the drain, leading to greatly reduced drain capacity and ultimately road flooding at or near the drain opening. Additionally, the flow of water through a drain that is clogged or partially clogged with debris is likely to result in the release of some or all of the debris into the flow of water continuing downstream from the drain. Often this trash, plant material, and other debris flows into oceans, creeks, rivers, and streams. To reduce the incidence of flooding, municipalities often expend considerable resources and employee time cleaning accumulated debris out of drains and drain basins to reduce the risks of roadway flooding and pollution.

Drain grates, positioned at or in a drain opening, have been developed to block the entry of debris into the drain system. This allows the debris to be removed by a street sweeper or by other conventional roadway cleaning techniques. To block the entry of debris while maintaining optimum drainage capacity, the grate should be removable from the drain opening when the flow of water through the drain reaches and exceeds a predetermined rate.

In dry and low water flow situations, the drain grate would remain closed in the drain opening, permitting passage of water through the grate, but blocking debris too large to fit through the grate. In higher water flow situations, an actuator connected to the drain grate would cause the drain grate to move away from the drain opening, thus increasing the flow capacity through the drain. The actuator of these systems typically comprised a container having a drain opening. These movable drain grates, while desirably preventing debris accumulation during relatively dry weather and allowing higher flow capacity during high water flow periods, remain prone to flooding in certain high water flow periods. In certain instances, enough water accumulates in the basin portion of the drain that the actuator floats in the accumulated water. Since the actuator is operatively connected to the drain grate, the flotation of the actuator closes the drain grate, thereby reducing the flow capacity of the drain opening. Thus, flow through the drain is reduced during instances (high water flow) when increased flow capacity is most desired.

Furthermore, some of the attempted solutions require a relatively deep basin to operate effectively. The depth of a roadway drain can be dependent on its distance from a drainage system outlet such as a stream, river, lake, or ocean, such that the drainage system floor has a slope to provide gravity feed from all of the individual drains to the endpoint without pooling. Thus, actuators in some of the previous drain grate actuation systems could not be sized to fit a relatively shallow drain basin. Additionally, various cities and counties have drafted rules and regulations limiting the size of acceptable drain grate systems such that many of the previous designs are no longer acceptable.

In light of the shortcomings of the prior art noted above, there is a need for a drain grate system that prevents the accumulation of debris in the drainage system during dry weather, that opens the grate for increased capacity in response to relatively high water flow conditions, that remains open despite water accumulation in the drain and that meets the needs of various city and county regulations.

### SUMMARY OF THE INVENTION

According to some embodiments, a drain grate system comprises a grate, a force plate and an energy plate. The grate can be configured to filter flows of liquid therethrough, having a closed position and an open position. The force plate can lock and unlock the grate in the closed position and can be pivotally connected to the grate, creating a moment arm. The moment arm can extend along the grate when the grate is in the closed position. The energy plate can be attached to the grate, for directing a flow of liquid against the force plate. The drain grate system can be configured so that the flow of liquid acting upon the moment arm of the force plate causes an end of the force plate to rotate away from the grate about the pivot attached to the grate, thereby unlocking the grate and allowing the grate to move to an open position.

In certain embodiments the force plate and energy plate create lift to help open the grate. Depending on the configuration of the embodiment, the force plate can rotate about a vertical axis.

The drain grate system may further comprise an arm fixed in relationship to a drain opening and a latch configured to engage a recess in the arm to lock the grate in the closed position. The latch can be pivotally connected to the grate. It may also further comprise a second force plate configured to act on the latch to unlock the drain grate system, wherein a flow of liquid acting on either or both of the force plates can unlock the drain grate system.

Some embodiments of a storm drain grate system comprise a gate, first and second force plates and a locking mechanism. The gate can be rotatable between a closed position and an open position and configured to allow fluid flow therethrough while preventing passage of debris of a predetermined size and shape when in the closed position. The first force plate can be configured to rotate about a first axis in a first direction. While the second force plate can be configured to rotate about a second axis in a second direction opposite the first direction, the first axis substantially parallel to the second axis. The first and second force plates can be configured to rotate independently by a predetermined amount of force of a flowing liquid. The locking mechanism can return to a locked position when the gate is in the closed position and the rotation of either or both of the first and second force plates can unlock the locking mechanism and allowing the gate to rotate from the closed position to the open position.

A storm drain grate system of some embodiments can further comprise first and second energy plates. The energy plates can be positioned to direct fluid flow towards the first and second force plates. Also, an active face of the force plates and the gate can be substantially vertical when the storm grate system is in the closed and locked position.

Embodiments can also include a method of opening a storm drain grate. The method of certain embodiments comprising passing at least a portion of a fluid flow through a grate, directing at least a portion of the fluid flow against a force plate, rotating a force plate about a first axis to unlock a locking mechanism and creating lift to rotate the grate about a second axis to an open position. The step of creating lift can comprise creating lift with the force plate, wherein the force plate is attached to the grate.

In the methods of the different embodiments, creating lift with the grate can comprise flowing at least a portion of the fluid flow against the grate such that the grate rotates away from a closed position. Additionally, creating lift with the force plate can comprise flowing at least a portion of the fluid flow against the force plate such that the grate rotates further away from the closed position. This may also involve directing at least a portion of the fluid flow against the force plate with an energy plate.

A storm drain grate locking mechanism can comprise a fixed first interlock portion, a hinged actuation member, configured to open a locking mechanism and a second interlock portion engaged with the first interlock portion when the locking mechanism is in a locked position, the second interlock portion configured to rotate. Rotating the actuation member about a cam can cause the actuation member to rotate about an axis while at the same time moving along the axis, the axial displacement causing the second interlock portion to rotate and disengage from the first interlock portion to move the locking mechanism to an unlocked position.

The storm drain grate locking mechanism of some embodiments can further comprise a second cam configured to increase the displacement of the second interlock portion to thereby increase the amount of rotation experienced by the second interlock portion, a second hinged actuation member and a third interlock portion. Rotation of the second actuation member about a third cam can cause the second actuation member to rotate about an axis while at the same time moving along the axis, the axial displacement causing the third interlock portion to rotate and to contact the second interlock portion thereby disengaging the second interlock portion from the first interlock portion.

### BRIEF DESCRIPTION OF THE DRAWINGS

FIG. 1 illustrates a side view of an embodiment of a drain grate system.

FIG. 2 shows an exploded rear view of part of the drain grate system of FIG. 1.

FIG. 3 illustrates a perspective view of a self locking mechanism for a drain grate system.

FIG. 4 illustrates a rear view of the self locking mechanism of FIG. 3.

FIG. 5 illustrates a front view of another embodiment of a drain grate system.

FIG. 5A shows a front view of the drain grate system of FIG. 5 in an open position.

FIG. 6 shows a rear view of the drain grate system of FIG. 5.

FIG. 7 is a rear detail view of the drain grate system of FIG. 5 showing a self locking mechanism.

FIG. 8 illustrates a perspective rear detail view of a self locking mechanism of the drain grate system of FIG. 5.

### DETAILED DESCRIPTION OF THE PREFERRED EMBODIMENT

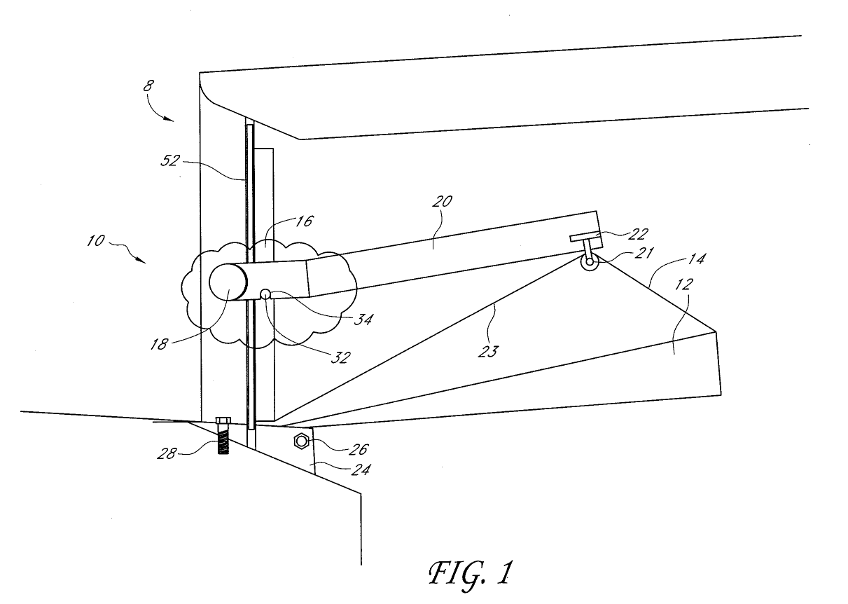

With reference to FIG. 1, in certain embodiments, a drain grate system 10 is provided comprising a grate 52 connected by a hinge to an opening of a drain 8, and a grate actuator 12 operatively coupled to the grate. The grate 52 is configured to allow the flow of a liquid therethrough and to block passage of debris therethrough. The grate actuator 12 is operatively coupled to the grate 52 such that for small flow rates of liquid through the grate 52, the position of the actuator 12 does not cause the grate 52 to open and for larger flow rates of liquid through the grate 52, the actuator 12 causes the grate 52 to open.

The drain 8 can be any of the various types of drains, such as storm drains, curb basins, catch basins, etc. The distance from the drain opening to the back of the drain (not shown) varies and can be, for example, between 6″ and 24″ for smaller drains. Other drains can be much longer, for example, 3′ to 6′. The size of the drain opening can also vary. Examples include openings from 4″ to 18″ tall and 2′ to 50′ wide. Typical widths for drain openings include: 3.5′, 7′, 10′, 14′, 21′, 28′, 35′ and 50′.

The flow of liquid, such as water into a drain can vary greatly and can depend on the flow of the liquid but also the size of the drain. A low flow could be equal to a trickle of water or to the flow of a common garden hose, which can average about 10 gals/min. A high rate of flow caused by a downpour of rain can be equal to, for example, a rate of flow of 2 to 3 ft³/s. A common high rate of flow used by the county of Los Angles, Calif. to test drain grate systems is 5 ft³/s (2244 gals/min). Other high rates of flow could be lower or higher then the rates given.

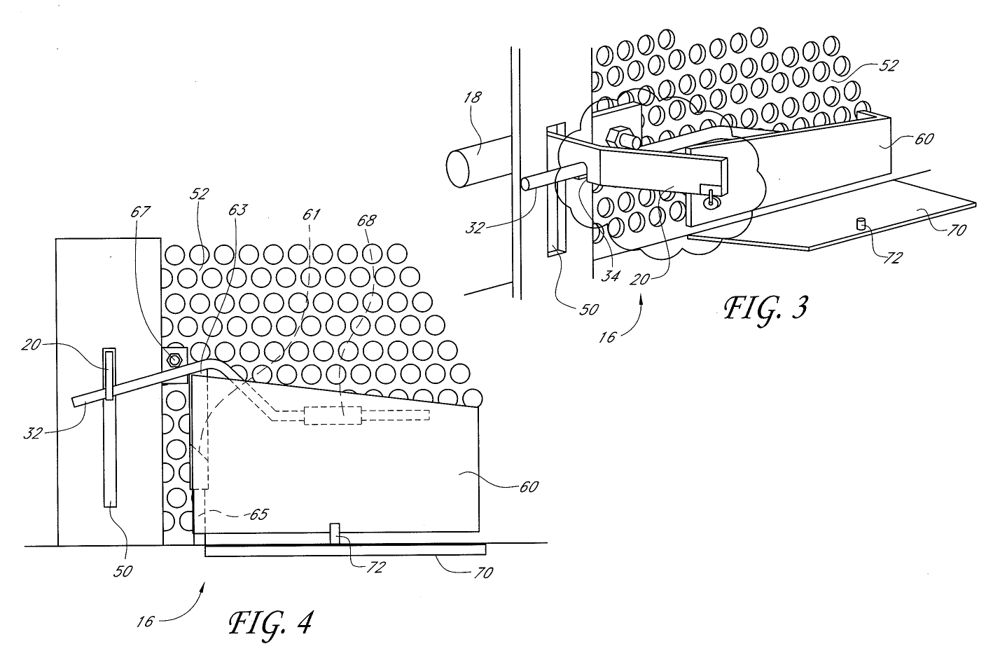

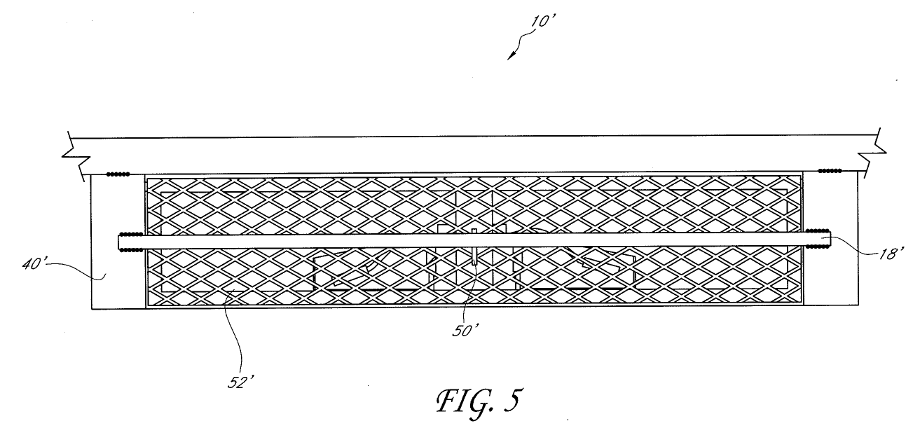

FIG. 1 shows an embodiment of a drain grate system 10 installed in a curbside basin or storm drain 8. As seen in FIG. 1 the drain grate system 10 can comprise a drain grate 52, an actuator 12, and an actuation mechanism 14. As discussed further with respect to FIGS. 3 and 4, some embodiments of the drain grate system can also comprise a locking mechanism 16.

As can be seen in FIG. 1, an actuator 12 can be coupled to the drain grate 52 with an actuation mechanism 14. In some embodiments, the actuator 12 can comprise a water tray and the actuation mechanism 14 can comprise a cable 23. The cable 23 can be routed from the actuator 12 through a routing device such as a pulley 21 and can then be connected to the grate 52.

The drain grate system 10 can work as follows. In some embodiments, a flow of liquid, such as water can flow through and/or around the grate 52 and onto the actuator 12. When the amount of liquid on the actuator 12 has reached a certain point, the weight of the liquid can cause the actuator 12 to move downward. As the cable 23 is connected to both the grate 52 and the actuator 12, the downward movement can cause the cable 23 to pull on and thereby open the grate 52.

With continued reference to FIG. 1, in some embodiments, a pulley 21 can be mounted on an arm 20 extending from a fixed protective bar 18, which extends across the curbside opening. In some embodiments, the arm 20 can have a slot 22 therein to receive the pulley 21. Thus, advantageously, the pulley 21 need not be mounted to a wall or ceiling of the basin itself, which can be labor-intensive and unfeasible in certain installations having relatively small basins. Rather, the pulley 21, and thus the actuation mechanism 14 can be installed from curbside, allowing a relatively fast and easy installation of the routing device.

Still referring to FIG. 1, the actuator 12 can be pivotally coupled to a foot 24 of the drain grate system 10 with a pivotable fastener 26 such that flow of water through the drain grate 10 pivots the actuator 12. The foot 24 can be coupled to the curbside basin, such as with a fastening bolt 28. Thus, advantageously the installation of the actuator 12 can also be accomplished from curbside as the fastening bolt 28 can be positioned relatively close to the street side of the drain.

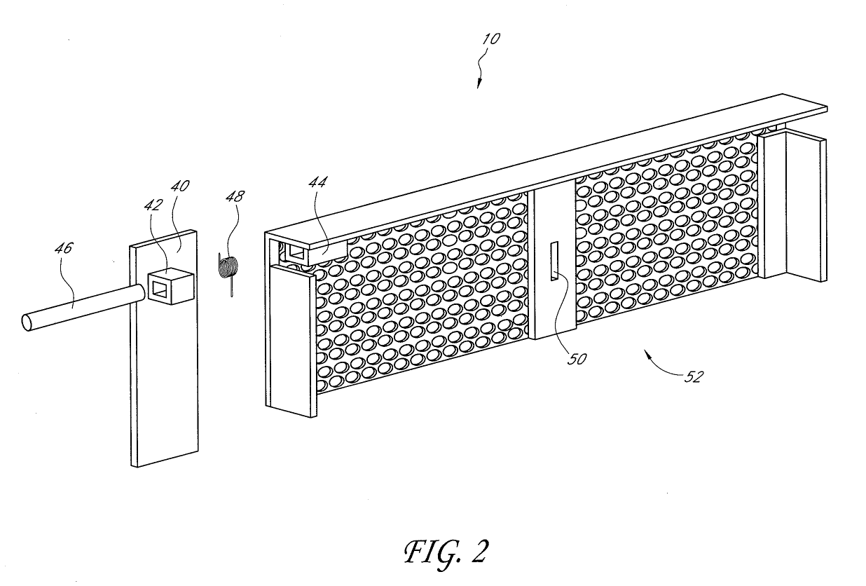

Now turning to FIG. 2, an exploded rear view of some embodiments of a drain grate system 10 is shown. In the illustrated embodiment, the drain grate 10 includes a frame and a mesh surface spanning the frame. The mesh surface can comprise, for example, a metal screen or a wire surface. The holes in the mesh surface can be configured to allow liquid to flow through the surface while not allowing debris of a certain size and shape to pass through the surface. The drain grate 10 can be pivotally coupled to one or more legs 40, which can vertically span the curbside opening. In some embodiments, a foot 24, as described above with reference to FIG. 1, can be coupled to each leg 40. In the illustrated embodiment, the drain grate 10 is pivotally coupled to the leg 40 with a hinge arrangement comprising an axle or rod 46 extending through passageways 42, 44 in the leg 40 and the drain grate 52. This hinge arrangement can be biased such that the drain grate tends to remain in the closed position. A spring 48 or other biasing member can be used to bias the drain grate 10 in the closed position. The weight of the drain grate 52 can also be used to bias the drain grate system 10 in the closed position without the use of a spring or biasing member. As illustrated, the drain grate 52 can include a slot 50. The slot 50 can allow the arm 20 to pass through the drain grate 52. The arm 20 of some embodiments is attached to the fixed protective bar 18. In some embodiments the arm 20 is attached to a leg 40. Relatedly, some embodiments can have more than one fixed protective bar 18.

With reference to FIGS. 3 and 4, a locking mechanism 16 for a drain grate system 10 is shown. The locking mechanism 61 can prevent the grate 52 from opening unless there is a sufficient flow of liquid therethrough. In some embodiments, the locking mechanism 16 can include a force plate 60 configured to move responsive to a flow of liquid through the drain grate 52. The locking mechanism 16 can also include a latch member 32 having a first or locked position in which the latch member 32 prevents movement of the drain grate 52 with respect to the arm 20 and a second or unlocked position in which the latch member 32 allows relative movement of the drain grate 52 with respect to the arm 20. In some embodiments, the arm 20 can include a recess 34 formed therein to receive the latch member 32 in the locked position and to prevent movement of the drain grate 52 relative to the arm 20.

With continued reference to FIGS. 3 and 4, the functioning of some embodiments of a locking mechanism 16 will be described. Liquid, such as water, flowing into the drain 8 through the grate 52 can come into contact with a force plate 60. When the flow of water reaches a predetermined pressure against the force plate 60, the force plate 60 can be forced to pivot away from the grate 52. In some embodiments, the force plate 60 can pivot at a cam interface 61 defined by a first or upper interface surface and a second or lower interface surface. The force plate 60 can act as a moment arm that extends along the grate 52. The length and size of the force plate 60, among other features, can help determine the amount of force of a flow of liquid need to rotate the force plate 60. In some embodiments, the force plate 60 extends along a substantially length of the grate 52. In some embodiments, one size of force plate 60 is used independent of the length of the grate 52 or drain opening.

A rod 65 can be attached to the grate 52 and to one half of the cam interface 61. The force plate 60 can be attached to the other half of the cam interface 61 and can rotate about the rod 65. As the force plate 60 rotates about the rod 65, the two halves of the cam interface 61 work together to raise the force plate 60 along the axis of the rod 65. Thus, in some embodiments, the lock mechanism 16 can include a cam interface 61 such that the pivoting motion of the force plate 60 is accompanied by vertical displacement of the force plate 60. In some embodiments the cam interface 61 can be at an angle of approximately 45° relative to the horizontal. The angle can be more or less aggressive depending on the desired vertical displacement. For example, the angle can be between 15° and 75° and more preferably between 30° and 60°. This raising up or vertical displacement of the force plate 60 can be used to unlock the locking mechanism 16.

In some embodiments, a latch member 32 can be rotated by the raising up of the force plate 60 to unlock the locking mechanism 16. As seen in FIGS. 3 and 4, a latch member 32 is engaged in a recess 34 of the arm 20. The latch member 32 can be pivotally coupled to the drain grate 52 such as with a pivot 67. The pivot 67 in some embodiments can be a flange defining an opening mounted on a pivot rod. Raising the force plate 60 can engage the force plate 60 with the latch member 32, causing the latch member 32 to rotate about the pivot 67 and disengage the recess 34. Once the latch member 32 is released from the arm 20, the grate 52 can be allowed to pivot, thus allowing the drain grate system 10 to move away from the closed position and to an open position.

In some embodiments, the force plate 60 can engage the latch member 32 at a second cam interface 63 defined by a first or upper interface surface and a second or lower interface surface. This second cam interface 63 can further increase the rate at which the latch member 32 is forced to rotate and to disengage the recess 34. Thus, in the illustrated embodiment, pivotal rotation of the force plate 60 responsive to liquid flow through the grate 52 can cause vertical displacement of a portion of the latch member 32 through a dual cam interface 61,63. In other embodiments, a single cam interface can convert rotation of the actuation plate 60 into vertical displacement of a portion of the latch member 32 to unlock the locking mechanism 16.

In some embodiments, the second cam interface 63 is between 10° to 12°. It is contemplated that in other embodiments of locking mechanism 16, other angles than those mentioned previously, can be used for the cam interface 61 and/or the second cam interface 63. In addition, in some embodiments the cam interface(s) can be angled in the other direction from that shown, such that rotation of the force plate 60 lowers the force plate 60 and/or lowers a portion of the latch member 32. As shown, the force plate 60 rotates about a substantially vertical axis at rod 65. In other embodiments, the force plate 60 can rotate about a substantially horizontal axis or about a diagonal axis.

The lock mechanism 16 can desirably have a self-locking mechanism. For example, the lock mechanism 16 can include a counterweight 68 disposed on the latch member 32 opposite an end of the latch member that interfaces with the arm 20 such that the latch member 32 tends to remain in the locked position. In some embodiments, the counterweight 68 can be on the same end as the portion of the latch member 32 that interfaces with the arm 20; for example, where the latch member 32 interfaces at a top of the arm 20 instead of at the bottom as is show in the figures.

After the latch member 32 is disengaged from the recess 34 in the arm 20, the latch member 32 can track along the arm 20 as the grate 52 opens. The arm 20 can be straight or curved upward, downward, to the side or some combination of these and other configurations. The arm 20 and latch member 32 can be used to limit the rotation of the grate 52. For example, the latch member 32 can have a bent end configured to catch the arm 20 and not allow the latch member to move along the arm 20 any farther. This can stop the rotation of the grate 52, thus preventing the grate 52 from opening further.

Other variations of the force plate 60 and the latch member 32 are also contemplated. For example, the force plate 60 and latch member 32 could be directly connected, or the force plate 60 could push the latch member 32 away from the grate 52 instead of up or down, or the force plate 60 could be angled to push the latch member 32 up or down. The latch member 32 could be on the other side of the force plate 60 away from the grate 52. The latch member 32 could also be bent or rotated or otherwise configured in ways than those shown in the figures.

In some embodiments, the drain grate system 10 can comprise an energy plate 70. The energy plate 70 can be located proximate to the force plate 60 and can be configured to direct a flow of liquid at the force plate 60. In the illustrated embodiment, the energy plate 70 is fixed with respect to the grate 52. As can be seen in FIG. 3, in some embodiments the energy plate 70 is located under and perpendicular to the force plate 60. As liquid flows through the grate 52, it can force the force plate 60 to rotate and unlock the locking mechanism. As the force plate 60 rotates, some of the liquid can pass under the force plate 60. Thus, the force plate 60 can lose some of the energy derived from the flow of the liquid. This can result in relocking the drain grate system 10. The energy plate 70 can direct more of the liquid to press against the force plate 60. This can help the drain grate system 10 to remain open once the desired pressure has been reached and stay open while this water pressure is being experienced by the force plate 60.

The energy plate 70 of some embodiments is configured to direct fluid flow towards the force plate 60 throughout the entire rotation of the force plate 60. In some embodiments, the energy plate 70 directs fluid flow towards the force plate 60 through an initial segment of the rotation of the force plate 60.

As can be seen from the above discussion, the force plate 60 and locking mechanism 16 are fundamentally different from actuation and locking mechanisms of prior art designs. This is because the force plate is actuated by the force of the flowing liquid instead of the accumulated weight of the liquid in a basin or tray. As shown, the locking mechanism 16 and force plate 60 can be used with an actuator 12 to open and rotate the grate 52 but this is not necessary. As will be shown hereafter, the locking mechanism 16 and force plate 60 can also be used without any other actuation means such as the actuator 12. The force of a flow of liquid and the force plate 60 can be used to both unlock the locking mechanism 16 and open/rotate the grate 52.

In some embodiments the drain grate system 10 can comprise a restraint or stop 72. The restraint 72 can restrain the force plate 60 from moving past a certain point. This can help direct more liquid against the force plate 60 and keep the drain grate system 10 open. For example, without the restraint 72, under certain conditions, such as high liquid flows, the force plate 60 could be rotated until it is perpendicular to the grate 52. In this position, the resistance between the drain grate system 10 and the flowing water is decreased which can tend to close the drain grate system 10 or move the grate 52 towards the closed position. But this is undesirable as it is desirable for the drain grate system 10 to remain open at times of high liquid flow. The restraint 72 can allow the force plate 60 to open to a certain degree but not to exceed that amount. This can maintain the resistance between the drain grate system 10 and the flowing liquid and can therefore help to ensure that the drain grate system 10 is maintained in an open position.

The force plate 60, more particularly with the restraint 72, though this is not required, can act like a wing of an airplane or the hull of a ship to create and increase lift between the drain grate system 10 and a flow of liquid. High liquid flow flowing against the force plate 60 can create a high pressure zone at this interface, while the pressure behind the force plate 60 remains at a lower ambient pressure. Thus, lift is created by this difference in pressures across the force plate 60 much like an airplane wing. The restraint 72 helps to maintain the position of the force plate 60 to help ensure that there is a difference in pressure between the front and the back of the force plate 60, thus ensuring that the grate 52 experiences lift as long as there are high fluid flows creating high pressure in front of the force plate 60.

The restraint 72 of some embodiments comprises a peg attached to the energy plate 70 as can be seen in FIGS. 3 and 4. In this embodiment, the force plate 60 can rotate until it contacts the peg. Thus, the peg limits the rotation of the force plate 60 to help maintain a balance between the force of the liquid against the drain grate system 10 and the force of the drain grate system against the flow of liquid.

Some embodiments can comprise multiple restraints 72. Another example of a restraint 72 includes a limiting arm. The limiting arm can be attached to one of the many different parts of the drain grate system 10 or the basin 8. For example, the limiting arm can be attached to one of the force plate 60, the arm 20, the grate 52, etc.

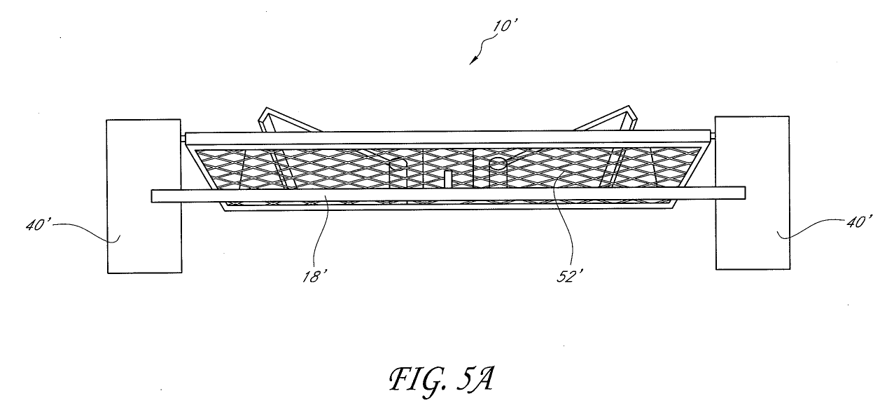

Now turning to FIGS. 5-8, a preferred embodiment of a drain grate system 10′ is shown. Numerical reference to components is the same as in the previously described arrangement, except that a prime symbol (′) has been added to the reference. Where such references occur, it is to be understood that the components are the same or substantially similar to previously-described components.

FIG. 5 is a front view of a drain grate system 10′. Components shown include a fixed protective bar 18′, a grate 52′, legs 40′ and a slot 50′. In some embodiments, the drain grate system 10′ can comprise more than one fixed protective bar 18′. In some embodiments, the components shown can be arranged in different relationships than those illustrated. The drain grate system 10′ is shown in a closed position. In this position, liquid can flow through the drain grate system 10′ but debris of a certain size and shape will not be able to pass through the holes in the grate 52′.

FIG. 5A shows the drain grate system 10′ in an open position. As shown, the grate 52′ has been rotated so that liquid can pass through and under the grate 52′ and debris can pass under the grate 52′. This can allow high flows of liquid to enter a drain while ensuring that debris does not enter at a time other than times of high liquid flow.

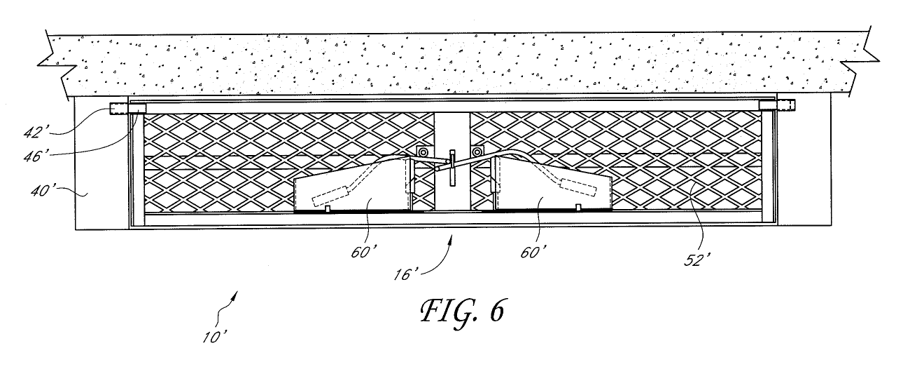

A rear view of the drain grate system 10′ is illustrated in FIG. 6. The drain grate system 10′ can comprise a locking mechanism 16′ with two force plates 60′. The drain grate system 10′ can have a grate 52′ that opens and closes and is connected to the legs 40′ with rod 46′ and passageway 42′. This can allow the grate 52′ to pivot about the axis of the rod 46′.

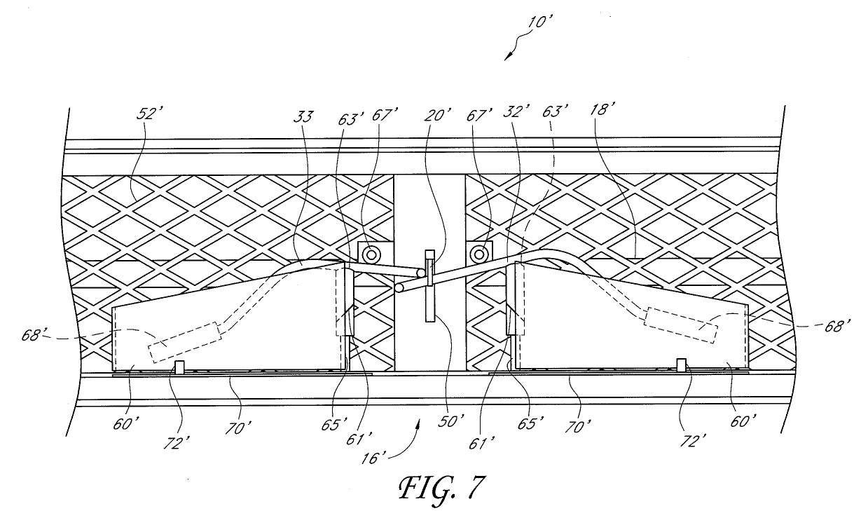

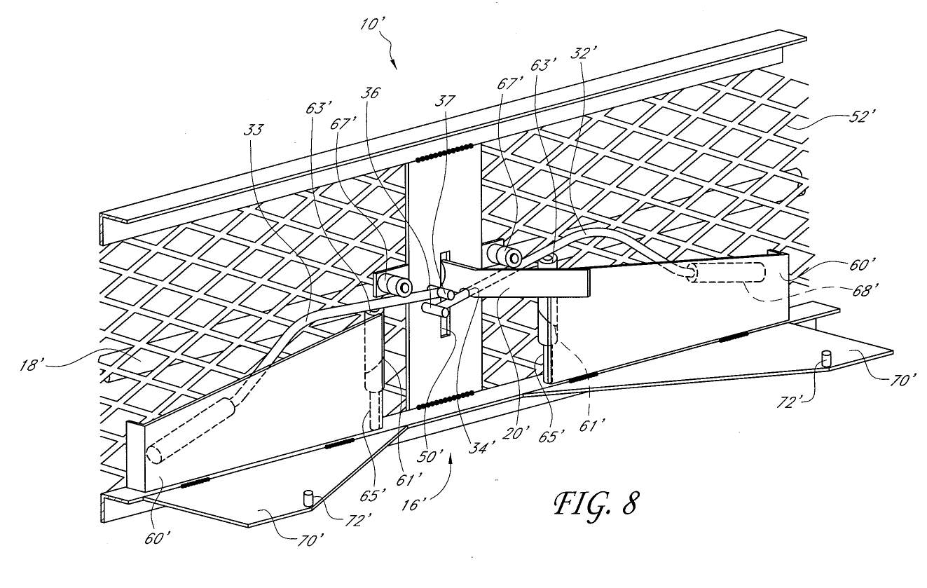

A locking mechanism 16′ will now be discussed with reference to FIGS. 7 and 8. A locking mechanism 16′ can utilize two force plates 60′. In some embodiments with two force plates 60′, each force plate 60′ is on opposite sides of the arm 20′. Such a configuration is duly suited to handle typical rain water flows on city streets and other situations.

City streets are often made with either a high center or at a slight angle so that one side is higher than the other. Gutters can be formed along the sides of the street. This configuration allows liquid, such as rain water to flow off of the street and into the gutter. The gutter can then be configured to direct the liquid to a drain and thereby into a sewer or waterway system. Because liquid often flows along the gutter into the drain there are many situations where the liquid flows at an angle to the face of the grate 52′.

Advantageously, the two force plates 60′ can be configured to rotate away from the grate 52′ in opposite rotational directions, i.e. one to rotate to the right and one to rotate to the left. This can allow the locking mechanism 16′ to work well with liquid flows coming from different directions and addressing the drain grate system 10′ from different angles. For example, liquid flowing substantially perpendicular to the face of the grate 52′ can interact with either or both force plates 60′ to unlock the locking mechanism 16′. As another example, liquid flowing at an angle to the face of the grate 52′ can efficiently act against the particular force plate 60′ that after some initial rotation becomes perpendicular to the flow of the liquid. As high flows of liquid are likely to come from multiple angles and because common city gutter systems are configured to flow liquid into the drain from the side, a drain grate system 10′ with a locking mechanism 16′ is configured to quickly adapt to multiple situations where other prior art drain grate systems are more likely to be less responsive and to take more time to open in response to high liquid flows. Conveniently, the two force plates 60′ can be configured such that each force plate 60′ rotates in the direction from which flow is likely to come, i.e. the left (with FIG. 6 as the reference) force plate 60′ rotates to the left and is more responsive to flow from the left then is the right force plate 60′, while the right force plate 60′ rotates to the right and is more responsive to flow from the right then is the left force plate 60′.

A locking mechanism 16′ with two force plates 60′ can function in the same or substantially the same way as previously described with one force plate 60. Alternatively, the two force plates 60′ of the locking mechanism 16′ can be linked so that only one needs to be acted upon to unlock the locking mechanism 16′ and thereby allow the drain grate system 10′ to open. In some embodiments, a latch member 32′ can be acted upon by either force plate 60′. In some embodiments, the locking mechanism 16′ has a latch member 32′ and a push member 33. The push member 33 can be rotated by a force plate 60′ as previously described with regard to the latch member 32 but instead of engaging the arm 20′, the push member 33 can engage the latch member 32, pushing the latch member out of engagement with the recess 34′ and allowing the drain grate system 10′ to open.

In some embodiments, either or both of the latch member 32′ and the push member 33′ can have an engagement surface 36, 37. The engagement surface(s) 36, 37 can be configured to engage either the other member 32′ or 33′ or the other engagement surface 36 or 37. In some embodiments, the engagement surface 36, 37 is defined by a knob at the end of the latch member 32′ and/or the push member 33′. The knob increases the surface area of the member available to contact by the other member to ensure proper contact is made between the members 32′, 33′. An engagement surface 36 defined by the knob on the latch member 32′ can also be used to limit how much the grate 52′ is able to open. As the grate 52′ opens, the latch member 32′ tracks along the length of the arm 20′. When the knob 36 reaches the arm 20′ continuing movement of the latch member is halted and the grate 52′ is prevented from opening further.

In some embodiments, the slot 50′ can be used to limit the rotation of the grate 52′. The length of the slot 50′ and the length of the arm 20′ can determine whether or not the slot 50′ and arm 20′ engage each other. In some embodiments, the slot 50′ is sufficiently long so as not to engage the arm 20′. In some embodiments, the slot 50′ is configured to allow the grate 52′ to open to a set point. In some embodiments, the slot 50′ is sufficiently long to allow some other part of the drain grate system 10′ to control and/or limit the opening of the grate 52′.

The drain grate system 10′ has many benefits. For example, the only components on the sides of the drain are the hinges about which the grate 52′ rotates. The moving components of the locking mechanism 16′ are attached to the grate 52′ and remain protected behind the grate 52′ from large debris. Many of the currently available systems other than the drain grate system 10′ have components to the sides of the grate. Once the grate is opened on these other drain grate systems the side components can be subject to the flow of debris such as leaves, sticks, litter, etc. This debris can interfere with or hinder the proper functioning of these other drain grate systems. For example, leaves or sticks can get stuck in these locking mechanisms on the sides. This can cause the system to not be able to lock or shut fully after the flow of liquid has subsided. This design also subjects the working parts of the drain grate system to the most abuse as debris flows directly at, around and through the sides of the drain opening. As discussed above, the drain grate system 10′ does not suffer from these problems as the locking mechanism 16′ is protected by and moves with the grate 52′.

Beneficially, the disclosed embodiments can all be installed at the drain opening and do not require other interior assemblies to be installed within the drain. The various systems for locking and opening the grate are fairly small compared to the prior art and require only a small amount of displacement which allows them to be used in most drain sizes. Thus a city or county can install one type of drain grate system throughout the city or county which has the potential to save costs in maintaining and installing the systems. In addition, there are no small moving parts or tight tolerances. This allows the disclosed embodiments to take a large amount of wear and tear without the need for maintenance which is an important consideration to cities and counties purchasing these units. In particular, in the illustrated embodiments there are no biasing springs which can break or can malfunction due to debris interfering with their operation or can fail due to stress over time.

Another benefit of the disclosed embodiments is that as long as there is a sufficient flow into the drain the drain grate system can remain open. This can be true even if the drain is essentially flooded. There are no hanging buckets or troughs which require the weight of a liquid to press downward on them so that the grate will remain open. Rather, in the disclosed embodiments the force of the flow into the drain can keep the grate open.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Further, the various features of this invention can be used alone, or in combination with other features of this invention other than as expressly described above. Thus, it is intended that the scope of the present invention herein disclosed should not be limited by the particular disclosed embodiments described above, but should be determined only by a fair reading of claims presented in a non-provisional application based hereon.

What is claimed is:

1. A drain grate system comprising:
a grate configured to filter flows of liquid therethrough, having a closed position and an open position;
a force plate for locking and unlocking the grate in the closed position, the force plate pivotally connected to the grate and creating a moment arm, the moment arm extending along the grate when the grate is in the closed position; and
an energy plate attached to the grate, for directing a flow of liquid against the force plate;
wherein the flow of liquid acting upon the moment arm of the force plate causes an end of the force plate to rotate away from the grate about the pivot attached to the grate, thereby unlocking the grate and allowing the grate to move to an open position.

2. The drain grate system of claim 1, wherein the force plate and energy plate create lift to help open the grate.

3. The drain grate system of claim 1, wherein the force plate rotates about a vertical axis.

4. The drain grate system of claim 1, further comprising;
an arm fixed in relationship to a drain opening; and
a latch configured to engage a recess in the arm to lock the grate in the closed position.

5. The drain grate system of claim 4, wherein the latch is pivotally connected to the grate.

6. The drain grate system of claim 5, further comprising a cam interface causing the force plate to experience vertical displacement as it rotates and the vertical displacement of the force plate rotating the latch.

7. The drain grate system of claim 6, further comprising a second cam interface at the interface between the force plate and the latch to increase the rate of rotation experienced by the latch.

8. The drain grate system of claim 4, further comprising a fixed protective bar in front of the grate, the arm attached to the fixed protective bar and extending through the grate.

9. The drain grate system of claim 5, further comprising a counterweight connected to the latch.

10. The drain grate system of claim 5, further comprising a limiter attached to the latch and configured to engage the arm to limit the rotation of the grate.

11. The drain grate system of claim 1, wherein the energy plate directs a flow of liquid to the force plate throughout the rotation of the force plate.

12. The drain grate system of claim 1, wherein the energy plate is substantially perpendicular to the force plate.

13. The drain grate system of claim 5, further comprising a second force plate configured to act on the latch to unlock the drain grate system, wherein a flow of liquid acting on either or both of the force plates can unlock the drain grate system.

14. The drain grate system of claim 13, further comprising a pivoting member connected to the grate, the second force plate acting on the pivoting member to rotate the pivoting member and to disengage the latch from the recess in the arm.

15. A storm drain grate system comprising:
a gate rotatable between a closed position and an open position and configured to allow fluid flow therethrough while preventing passage of debris of a predetermined size and shape when in the closed position;
a first force plate configured to rotate about a first axis in a first direction;
a second force plate configured to rotate about a second axis in a second direction opposite the first direction, the first axis substantially parallel to the second axis, wherein the first and second force plates are configured to rotate independently by a predetermined amount of force of a flowing liquid; and
a locking mechanism, returning to a locked position when the gate is in the closed position and the rotation of either or both of the first and second force plates unlocking the locking mechanism and allowing the gate to rotate from the closed position to the open position.

16. The storm drain grate system of claim 15, wherein the fluid flow against the force plates provides lift to help rotate the gate to the open position.

17. The storm drain grate system of claim 15, further comprising first and second energy plates, wherein the energy plates are positioned to direct fluid flow towards the first and second force plates.

18. The storm drain grate system of claim 15, wherein an active face of the force plates and the gate are substantially vertical when the storm grate system is in the closed and locked position.

19. A method of opening a storm drain grate comprising:
passing at least a portion of a fluid flow through a grate;
directing at least a portion of the fluid flow against a force plate;
rotating a force plate about a first axis to unlock a locking mechanism; and
creating lift to rotate the grate about a second axis to an open position comprising:
creating lift with the force plate, wherein the force plate is attached to the grate.

20. The method of claim 19, wherein creating lift with the grate comprises flowing at least a portion of the fluid flow against the grate such that the grate rotates away from a closed position.

21. The method of claim 20, wherein creating lift with the force plate comprises flowing at least a portion of the fluid flow against the force plate such that the grate rotates further away from the closed position.

22. The method of claim 19, wherein the step of creating lift further comprises directing at least a portion of the fluid flow against the force plate with an energy plate.

23. The method of claim 22, wherein the step of creating lift further comprises limiting rotation of the force plate.

24. A storm drain grate locking mechanism comprising:
a fixed first interlock portion;
a hinged actuation member, configured to open a locking mechanism; and
a second interlock portion engaged with the first interlock portion when the locking mechanism is in a locked position, the second interlock portion configured to rotate;
wherein rotating the actuation member about a cam causes the actuation member to rotate about an axis while at the same time moving along the axis, the axial displacement causing the second interlock portion to rotate and disengage from the first interlock portion to move the locking mechanism to an unlocked position.

25. The storm drain grate locking mechanism of claim 24, wherein the actuation member further comprises a second cam configured to increase the displacement of the second interlock portion to thereby increase the amount of rotation experienced by the second interlock portion.

26. The storm drain grate locking mechanism of claim 25, further comprising a second hinged actuation member and a third interlock portion, wherein rotation of the second actuation member about a third cam causes the second actuation member to rotate about an axis while at the same time moving along the axis, the axial displacement causing the third interlock portion to rotate and to contact the second interlock portion thereby disengaging the second interlock portion from the first interlock portion.
